(19) United States
(12) Patent Application Publication
(10) Pub. No.: US 2011/0116523 A1
(43) Pub. Date: May 19, 2011

(54) METHOD OF BEAM FORMATTING SE-DFB LASER ARRAY

(75) Inventors: Manoj Kanskar, Madison, WI (US); Yan Xiao, Madison, WI (US)

(73) Assignee: ALFALIGHT CORP.

(21) Appl. No.: 12/880,635

(22) Filed: Sep. 13, 2010

Related U.S. Application Data
(60) Provisional application No. 61/241,936, filed on Sep. 13, 2009.

(51) Int. Cl. H01S 3/00; H01S 3/0941

(52) U.S. Cl. 372/38.01; 372/75

(57) ABSTRACT

The present invention provides a method of fabricating a beam formatting diode laser using a surface-emitting distributed feedback (SE-DFB) laser array (SELA), instead of edge-emitting diodes that provides a brighter diode and results in simple and few optical components to reduce the complexity and cost of solid-state laser pump modules and direct-diode applications.

### CROSS REFERENCE TO RELATED APPLICATIONS

This application claims benefit under 35 U.S.C. §119(e) to U.S. Provisional Patent Application No. 61/241,936, filed Sep. 13, 2009, entitled “METHOD OF BEAM FORMATTING SE-DFB LASER ARRAY” (attorney docket number ALFA-022/PROV), the contents of which is incorporated herein in their entirety for all purposes.

### FIELD OF THE INVENTION

The present invention provides a method of formatting a laser beam for use with solid-state laser pump modules and direct-diode applications using a surface-emitting distributed feedback (SE-DFB) laser array (SELA) and passing the beam through a cylindrical lens. The disclosed methods use more simple and fewer optical components to reduce the complexity and cost.

### BACKGROUND OF THE INVENTION

High-power, multimode laser diodes are workhorses for many industrial applications. They are used as tools for cutting, welding, sintering and soldering various materials as well as pump sources for fiber lasers, disk lasers and solid-state lasers. Many of these applications require fiber-coupled output or a uniformly focused beam. The task of fiber-coupling and beam-formatting edge-emitting diode is not simple due to large and asymmetric beam divergence.

In order to focus the output beam necessary for fiber-coupling, expensive micro-optics arrays, inter-leavers and beam-transformation optics are needed to squeeze the power into a small fiber, and this drives-up the dollar-per-watt more than an order of magnitude higher than the cost of manufacturing the laser diode. Fiber-coupled or formatted beams are still too expensive or cost-prohibitive for many applications. Therefore fiber-coupled or formatted beams remain too expensive or cost-prohibitive for many applications.

Therefore, it would be useful to provide a less expensive method of providing brighter diodes with useful beam formats providing a fiber-coupled beam that does not need to be corrected for large and asymmetric beam divergence and therefore require less expensive and lower-cost manufacturing techniques to decrease the dollar-per-watt.

### SUMMARY OF THE INVENTION

The present invention provides a method of formatting a laser beam for use with solid-state laser pump modules and direct-diode applications using a surface-emitting distributed feedback (SE-DFB) laser array (SELA) and passing the beam through a cylindrical lens. The disclosed methods use more simple and fewer optical components to reduce the complexity and cost.

Therefore, in various exemplary embodiments the invention provides a method of formatting a laser beam comprising, using a surface-emitting distributed feedback (SE-DFB) laser array (SELA), passing the beam through a cylindrical lens, wherein the beam of the laser is formatted. In some exemplary embodiments the beam is collimated. In other exemplary embodiments the beam forms a line source using a single cylindrical lens and a SELA which has a nearly collimated output beam in the longitudinal direction and a divergent beam in the lateral direction. In still other exemplary embodiments, the beam forms a point source is by using one or more reflectors to guide the line source to a point source. In some exemplary embodiments the SELA is a two-dimensional array

In other exemplary embodiments the invention is a method of forming a line source from multiple SELAs comprising, passing the output beam through a single cylindrical lens. In various exemplary embodiments the line source is extended by stacking multiple SELAs in the lateral direction. In some exemplary embodiments the line source is intensified by stacking multiple SELAs in the longitudinal direction. In various exemplary embodiments, the multiple SELAs is a two-dimensional array. In some exemplary embodiments, multiple cylindrical lenses are used to form the line source.

In other exemplary embodiments, the invention provides a method of forming a concentrated line source from multiple SELAs comprising: positioning the SELAs at a constant radial distance from a line source; orienting the SELAs longitudinally and in the same longitudinal plane; and aligning one or more cylindrical focusing lens in the output beam path. In various exemplary embodiments, an intensified line source is formed by using a two-dimensional array of SELAs in step. In some exemplary embodiments a plurality of cylindrical focusing lenses are aligned to the SELAs generating a concentrated line source.

In still other exemplary embodiments, the invention provide method of pumping a solid-state or gas gain media using an array of SELAs comprising: stacking, periodically two or more SELA arrays with one or more cylindrical lens arrays.

In still other exemplary embodiments the invention provides a method of collimating multiple SELAs using a single cylindrical lens (FIG. 5A) comprising: locating the multiple SELAs at a radial distance away from a virtual line source; and locating a single cylindrical lens at a distance such that the focal length of the lens is approximately equal to its location from the virtual line source.

In still other exemplary embodiments the invention provides a method of collimating a two dimensional array of SELAs comprising: side-stitching the array of SELAs using a single cylindrical lens. In some exemplary embodiments, the method provides multiple cylindrical arrays are placed side by side to form a larger area of collimated beam. In various exemplary embodiments a point source is formed from the collimated beam using an aspherical lens.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be apparent from the description, as set forth hereinafter.

### BRIEF DESCRIPTION OF THE FIGURES

Various exemplary embodiments of the compositions and methods according to the invention will be described in detail, with reference to the following figures wherein:

FIG. 1 represents a method of forming a line source using just one cylindrical lens to focus ‘N’-number of SE-DFB lasers on a single SELA; (a) SE-DFB laser array (SELA). (b) Beam coming out of N-number of SE-DFB lasers focused into a line using single cylindrical lens. (c) Shows details of the beam coming from a few SE-DFB lasers. (d) Side-view showing a line source being formed from SELA with single cylindrical lens. (e) Lateral view. (f) Isometric illustration of line source formation using a single cylindrical lens. (g) shows a method of forming a line source with multiple vertically stacked SELAs using just one cylindrical lens. (h) Isometric view of multiple vertically stacked SELAs forming a line source with single cylindrical lens.

FIG. 2. (a) Longitudinal side-view of a 2D-stacked SELAs forming a line source with single cylindrical lens. (b) Lateral side-view of a 2D-stacked SELAs. (c) Isometric illustration of 2D-stacked SELA forming a line source using a single cylindrical lens. (d) Longitudinal side-view of curved 2D-stacked SELAs forming a line source using multiple cylindrical lenses. (e) Lateral side-view of curved 2D-stacked SELAs. (f) Isometric illustration of curved 2D-stacked SELA formed line source using multiple cylindrical lenses.

FIG. 3 (a) Longitudinal side-view shows a method of periodically stacking SELAs with one cylindrical lens for concentrated pumping from top and bottom. (b) Lateral side-view of concentrated pumping method. (c) Isometric illustration of the concentrated pumping method.

FIG. 4 A method of forming a point source from any of the above line source using mirrors of applicable shape. (a) Lateral side-view of a curved 2D-stacked array of SELAs forming a point source with multiple cylindrical lenses and two slab reflectors. The angle between the two reflectors can be placed as required to guide the line source into a point source. (b) Isometric illustration of the method of forming a point source with a line source and two reflectors.

FIG. 5 (a) A method of side-stitching an array of SE-DFB lasers with cylindrical wavefront so that an array of them can then be collimated using a single cylindrical lens. (b) A method of forming a uniform illumination source using a stack of these cylindrical wave-front side-stitched arrays. (c) Isometric illustration of the collimated cylindrically positioned SELAs. (d) Lateral side-view of 2D-stacked cylindrically positioned SELAs forming a point source with multiple cylindrical lenses and an asphecrical lens. (e) Longitudinal side-view of 2D-stacked cylindrically positioned SELAs forming a point source with multiple cylindrical lenses and an aspherical lens. (f) Isometric illustration of 2D-stacked cylindrically positioned SELAs forming a point source with multiple cylindrical lenses and an aspherical lens.

### DETAILED DESCRIPTION OF THE EXEMPLARY EMBODIMENTS

The present invention provides a method of formatting a laser beam for use with solid-state laser pump modules and direct-diode applications using a surface-emitting distributed feedback (SE-DFB) laser array (SELA) and passing the beam through a cylindrical lens. The disclosed methods use more simple and fewer optical components to reduce the complexity and cost.

Therefore, in various exemplary embodiments the invention provides a method of formatting a laser beam comprising, using a surface-emitting distributed feedback (SE-DFB) laser array (SELA), passing the beam through a cylindrical lens, wherein the beam of the laser is formatted. In some exemplary embodiments the beam is collimated. In other exemplary embodiments the beam forms a line source using a single cylindrical lens and a SELA which has a nearly collimated output beam in the longitudinal direction and a divergent beam in the lateral direction. In still other exemplary embodiments, the beam forms a point source is by using one or more reflectors to guide the line source to a point source. In some exemplary embodiments the SELA is a two-dimensional array

In other exemplary embodiments the invention is a method of forming a line source from multiple SELAs comprising, passing the output beam through a single cylindrical lens. In various exemplary embodiments the line source is extended by stacking multiple SELAs in the lateral direction. In some exemplary embodiments the line source is intensified by stacking multiple SELAs in the longitudinal direction. In various exemplary embodiments, the multiple SELAs is a two-dimensional array. In some exemplary embodiments, multiple cylindrical lenses are used to form the line source.

In other exemplary embodiments, the invention provides a method of forming a concentrated line source from multiple SELAs comprising: positioning the SELAs at a constant radial distance from a line source; orienting the SELAs longitudinally and in the same longitudinal plane; and aligning one or more cylindrical focusing lens in the output beam path. In various exemplary embodiments, an intensified line source is formed by using a two-dimensional array of SELAs in step. In some exemplary embodiments a plurality of cylindrical focusing lenses are aligned to the SELAs generating a concentrated line source.

In still other exemplary embodiments, the invention provide method of pumping a solid-state or gas gain media using an array of SELAs comprising: stacking, periodically two or more SELA arrays with one or more cylindrical lens arrays.

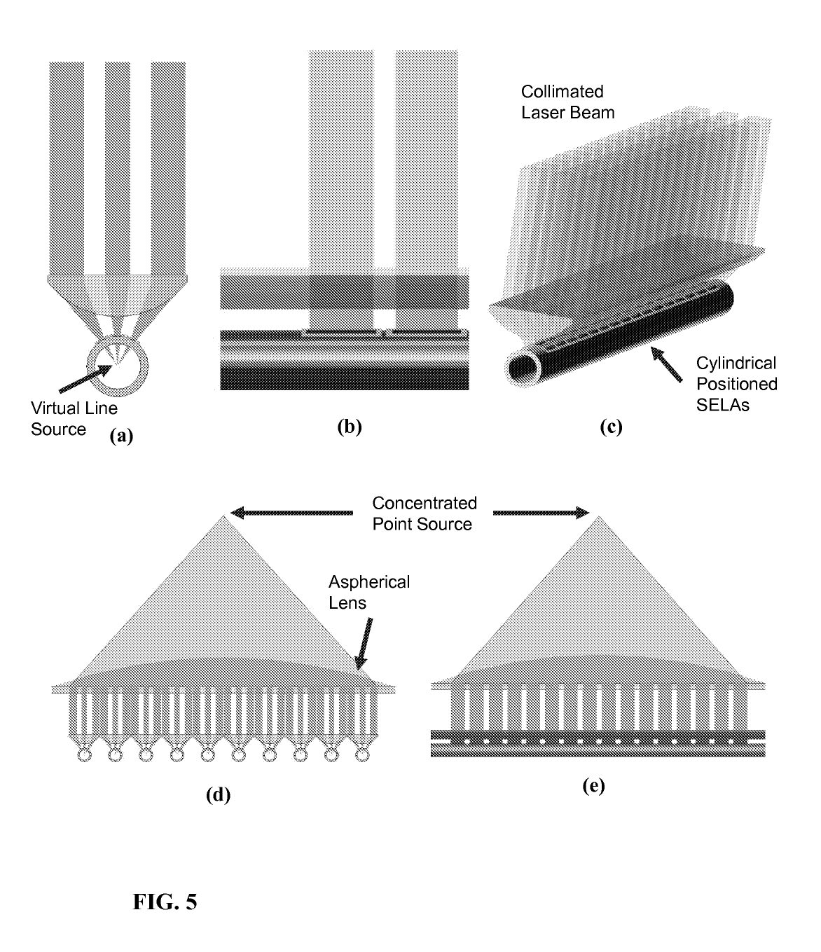

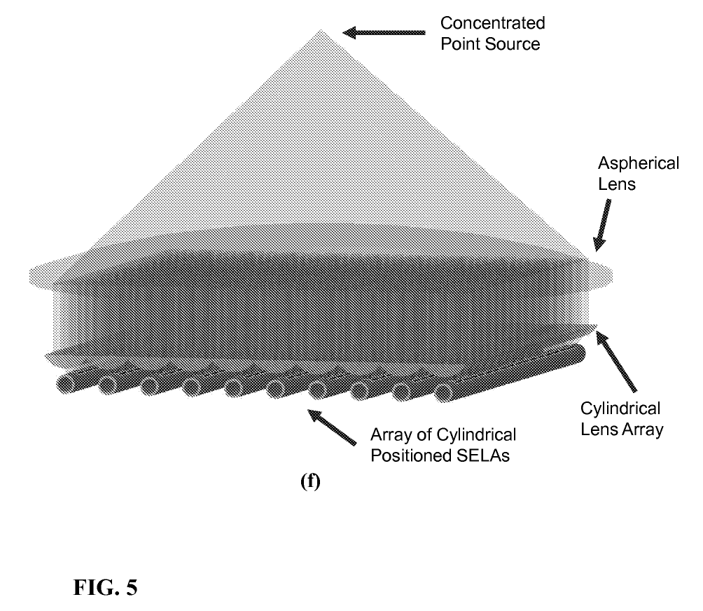

In still other exemplary embodiments the invention provides a method of collimating multiple SELAs using a single cylindrical lens (FIG. 5A) comprising: locating the multiple SELAs at a radial distance away from a virtual line source; and locating a single cylindrical lens at a distance such that the focal length of the lens is approximately equal to its location from the virtual line source.

In still other exemplary embodiments the invention provides a method of collimating a two dimensional array of SELAs comprising: side-stitching the array of SELAs using a single cylindrical lens. In some exemplary embodiments, the method provides multiple cylindrical arrays are placed side by side to form a larger area of collimated beam. In various exemplary embodiments a point source is formed from the collimated beam using an aspherical lens.

Why Brightness Matters

Spatial brightness is defined as power generated per given area and solid angle. Therefore, using brighter sources, more power can be focused on smaller areas or coupled into smaller fibers. An ideal way to generate high powers would be to combine single mode diode lasers. Unfortunately, such sources produce, at most, 1 W of useful power and would require unmanageable number of diodes for power-hungry industrial applications. Instead, multimode 100 μm wide, broad-stripe laser diodes are typically used. A single such device produces about 10 W of power out of a 100 μm 0.15 NA fiber with relatively simple coupling scheme, but further power scaling remains a challenge. Combining more chips helps to generate higher powers but at the penalty of higher cost and complexity. An alternative method uses fiber-coupling of bars and stacks. In this case, diffraction-limited collimators, expensive micro-lens arrays, inter-leavers and precision beam-formatting optics have to be used in high-tolerance, complex configurations. These sophisticated elements between the source and the fiber are what drive the cost of high-power fiber-coupled systems.

A Lower Cost Solution

Arrays of SE-DFB lasers have several key attributes lifting many limitations and cost drivers of current high-power laser diode systems. Those attributes are enabled by one crucial feature: a curved, second-order grating etched on the p-side cladding of the laser chip (see side-bar).

Producing SE-DFB chips is more efficient than making standard edge-emitting lasers because key steps are performed early in the manufacturing process. Since the fabrication of the laser output window and probe testing of individual lasers are performed directly on the wafer, known-good-dies are selected before the laser chips are even cleaved, avoiding potential yield losses at expensive downstream packaging steps.

The SE-DFB array architecture provides a number of additional cost-saving advantages over the current technology. Whereas edge-emitters have to be placed on the knife-edge of expensive, diamond-turned heat-sinks, SE-DFB lasers are simply picked and placed on a low-cost, flat heat-sink with an order of magnitude looser tolerance. Lasers in an SE-DFB array are wired in series, which substantially reduces power loss in cables and power supplies. Furthermore, low-current power supplies are cheaper, lowering the overall system cost. Another key advantage of the SE-DFB architecture is that the electrical connection is isolated from the coolant. This avoids galvanic corrosion that plagues micro-channel cooled bar stacks. Even at the kilowatt level, SE-DFB arrays are cooled with standard house water.

Customized Beam with Simple Optics

The simple way SE-DFB lasers are laid out on a heat-sink makes it straightforward to customize the geometry of an array for a given application. For example, certain applications require an asymmetrical, thin rectangular beam. This is the case for laser-based surface treatment, hardening, and cladding operations, where the beam is used as a broad optical brush to sweep large surfaces quickly. An SE-DFB laser array can be arranged into a few columns, each containing a number of laser chips. Because the beam is readily collimated straight out of the chip in one direction, no collimating optics is needed for individual chips. In the orthogonal direction, the beam diverges slowly with a full angle of about 8°. Each column can therefore be collimated with a single standard cylindrical lens. This architecture yields important cost savings with respect to the collimation of edge-emitting bars that requires expensive, diffraction-limited fast-axis collimation micro-lenses.

Fiber-Coupled SE-DFB Arrays

Previous experiments by the inventors using a curved grating resulted in a 200-W quasi-circular SE-DFB array coupled into a fiber cable with high efficiency without using beam transformation optics. In this configuration, four cylindrical lenses are used to collimate four columns in a 4-6-6-4 arrangement, and a single aspherical lens focuses the beam into a 200 μm, 0.22 NA fiber. The most stringent mechanical tolerance in this module with respect to fiber coupling is about 3 μm, two orders of magnitude looser than the 50-nm precision required for performing the same operation with a stack of laser bars. More rugged fiber-coupled SE-DFB products can be envisioned, handling shocks, vibrations and thermal gradients better than the current technology.

Our 200-W fiber-coupled module has been designed for pumping ytterbium-doped fiber lasers. The important challenge of wavelength yield for 976-nm modules is waived with SE-DFB technology, since the grating precisely determines the output wavelength and guarantees a wavelength yield of virtually one-hundred percent across the wafer. In addition to delivering a narrow spectrum centered on the ytterbium absorption peak, the technology comes with other practical advantages. For example, the wavelength shift over temperature is only 0.07 nm/° C., five times slower than standard laser diodes. The pump absorption in the doped fiber consequently has only a weak dependence on the cooling water temperature. On a system perspective, this means that several pump modules can be cooled with a unique chiller with no temperature tuning required to optimize absorption.

Wavelength-locked high-power laser diodes bring benefits to industrial applications other than pumping solid-state media. For example, laser soldering of thermoplastics is generally realized by overlapping a transparent with a strongly absorbent polymer. The laser beam is transmitted through the top layer to melt the bottom, absorptive material, joining both pieces upon cooling. Materials have to be carefully chosen to meet the respective requirements of high transmission and high absorption at the laser wavelength. SE-DFB arrays could provide low-cost solutions for this application, with an operating wavelength tuned on absorption and transmission bands of specific polymers.

Power Scaling

Multi-kilowatt SE-DFB arrays would be a good fit for pumping high-power thin disk lasers. A thin disk laser can be pumped with a single beam, reflected several times by the pump cavity and absorbed by the thin solid-state gain medium over multiple passes. The benefits of simpler pump architecture and an emission wavelength locked on the absorption band of the disk would generate important cost savings, especially when scaled at the kilowatt level.

Limitations taken for granted on brightness, architecture and yield of high-power laser diode manufacturing are being lifted as the very first generations of SE-DFB lasers are being integrated into prototypes. Whether used as direct laser sources or for pumping fiber and solid-state lasers, SE-DFB laser arrays will quickly become a game changer for industrial applications.

However, while these experiments showed the possibility of using curved-grating surface-emitting-DFBs, the fabrication of curved grating still is time consuming and increases the cost of making the laser. The inventors then conceived that the use of SE-DFB having linear gratings would still have the benefits of the curved grating but be much more versatile because not only are they easier to fabricate but they can be assembled in arrays of various designs allowing the beam to be formatted for use in a variety of ways.

Various exemplary embodiments of devices and compounds as generally described above and methods according to this invention will be understood more readily by reference to the following examples, which are provided by way of illustration and are not intended to be limiting of the invention in any fashion.

### EXAMPLE 1

### Formation of a Line Source Using Just One Cylindrical Lens

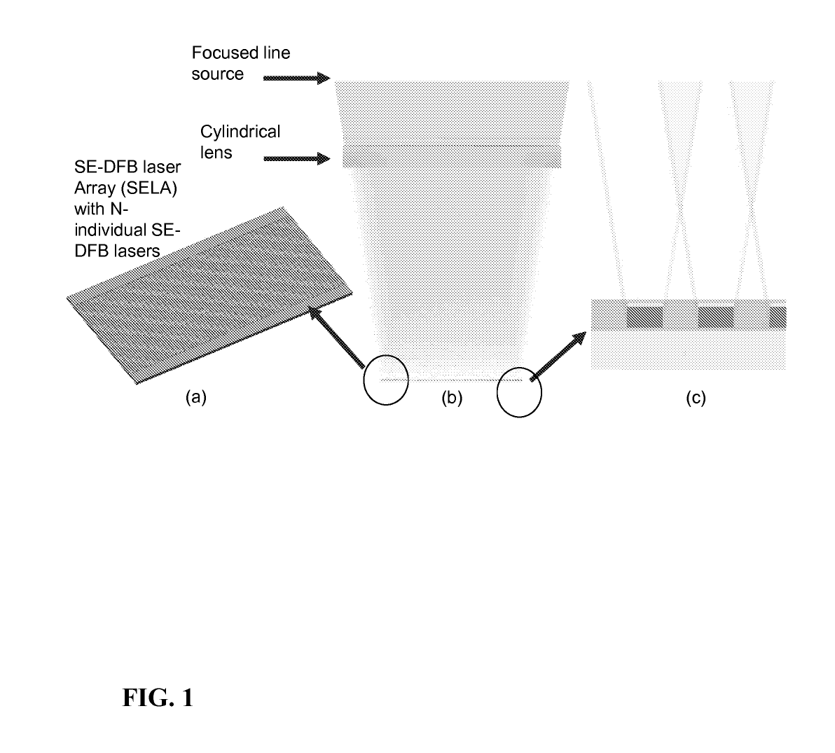

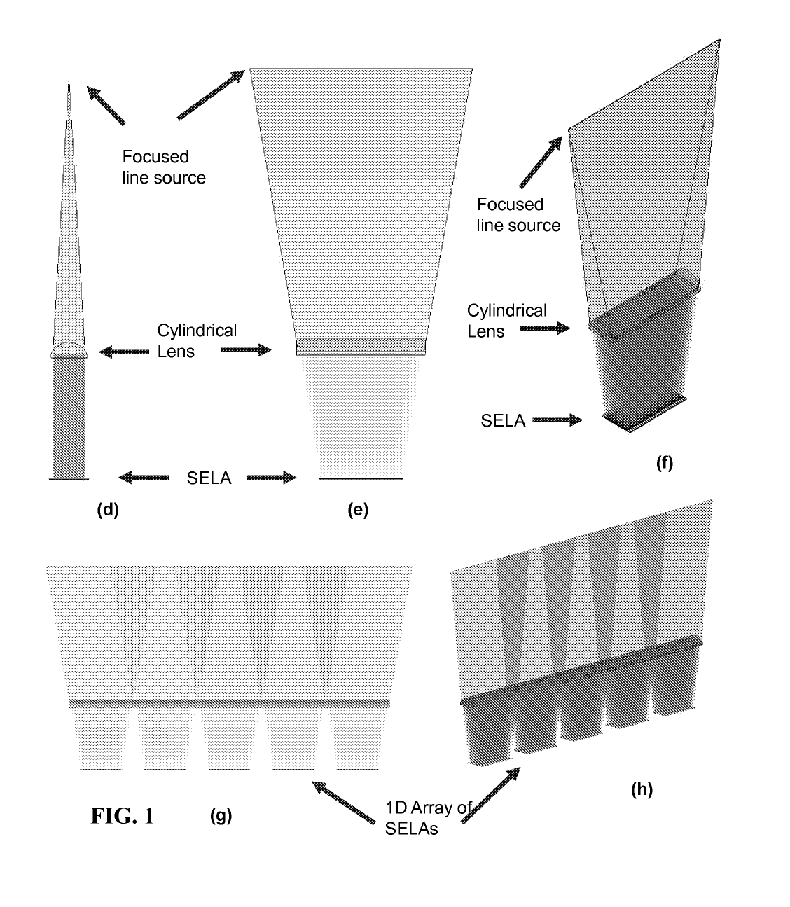

To validate the use of the surface emitting distributed feedback laser for the formation of a lines source the SE-DFBs and their arrays (SELAs) are fabricated as shown in FIG. 1. As illustrated, FIG. 1 represents a method of forming a line source using just one cylindrical lens to focus ‘N’-number of SE-DFB lasers on a single SELA. FIGS. 1 a-c shows an exploded view of the laser array where: FIG. 1 illustrates a SE-DFB laser array (SELA); and FIG. 1b represents the beam coming out of N-number of SE-DFB lasers focused into a line using single cylindrical lens. FIG. 1c shows details of the beam coming from a few SE-DFB lasers. FIG. 1d shows a side-view illustrating a line source being formed from SELA with single cylindrical lens. FIG. 1e is a lateral view of the design shown in FIG. 1d. FIG. 1f is an isometric illustration of line source formation using a single cylindrical lens. FIG. 1g shows a method of forming a line source with multiple vertically stacked SELAs using just one cylindrical lens. FIG. 1h is an isometric view of multiple vertically stacked SELAs forming a line source with single cylindrical lens.

### EXAMPLE 2

### Fabrication of a Line Source Using 2D SELAs

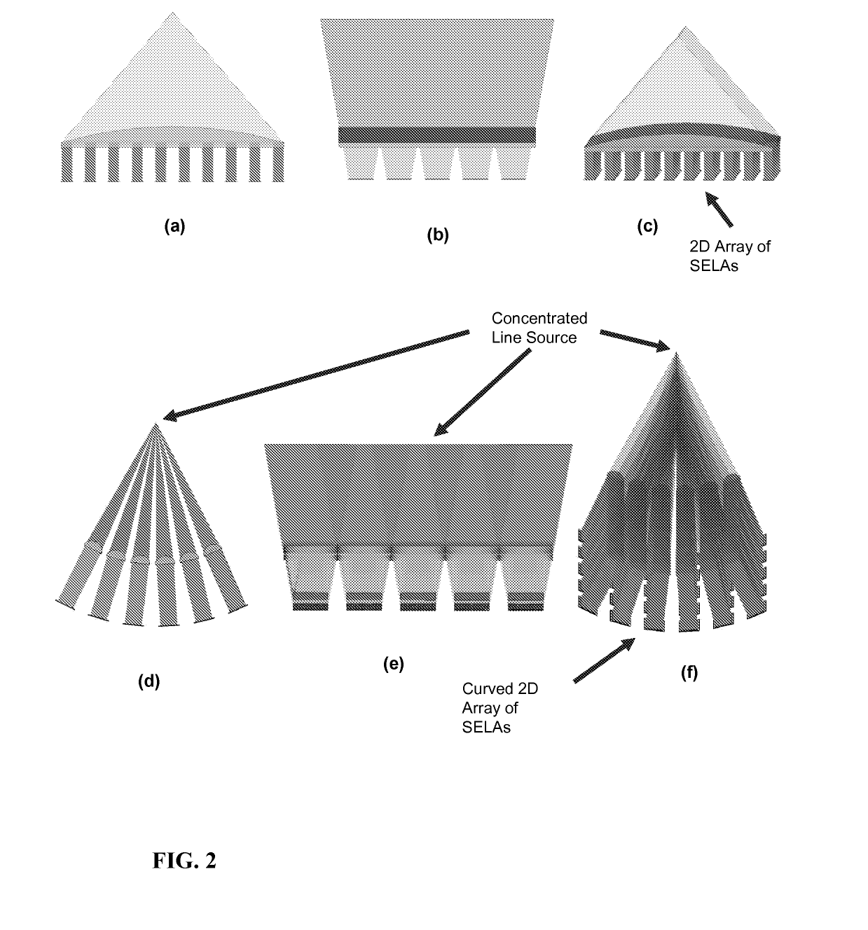

A two-dimensional array of SELA can also be used to form a line source. FIG. 2a shows a longitudinal side-view of a 2D-stacked SELAs forming a line source with single cylindrical lens. FIG. 2b is a lateral side-view of a 2D-stacked SELAs. FIG. 2c is an isometric illustration of 2D-stacked SELA forming a line source using a single cylindrical lens. FIG. 2d is a longitudinal side-view of a curved 2D-stacked SELAs forming a line source using multiple cylindrical lenses. FIG. 2e is a lateral side-view of the curved 2D-stacked SELAs shown in FIG. 2d. FIG. 2f is an isometric illustration of curved 2D-stacked SELA formed line source using multiple cylindrical lenses.

### EXAMPLE 3

### Use of Periodically Stacked SELAs to Concentrate for Pumping

The versatility of the SELA is illustrated in FIGS. 3a-c showing the use of SELAs stacked periodically with a cylindrical lens to concentrate the beam for pumping. FIG. 3a illustrates longitudinal side-view shows a method of periodically stacking SELAs with one cylindrical lens for concentrated pumping from top and bottom. FIG. 3b is a lateral side-view of concentrated pumping method. FIG. 3c is an isometric illustration of the concentrated pumping method.

### EXAMPLE 4

### A Method of Forming a Point Source from any of the Above Line Source Using Mirrors

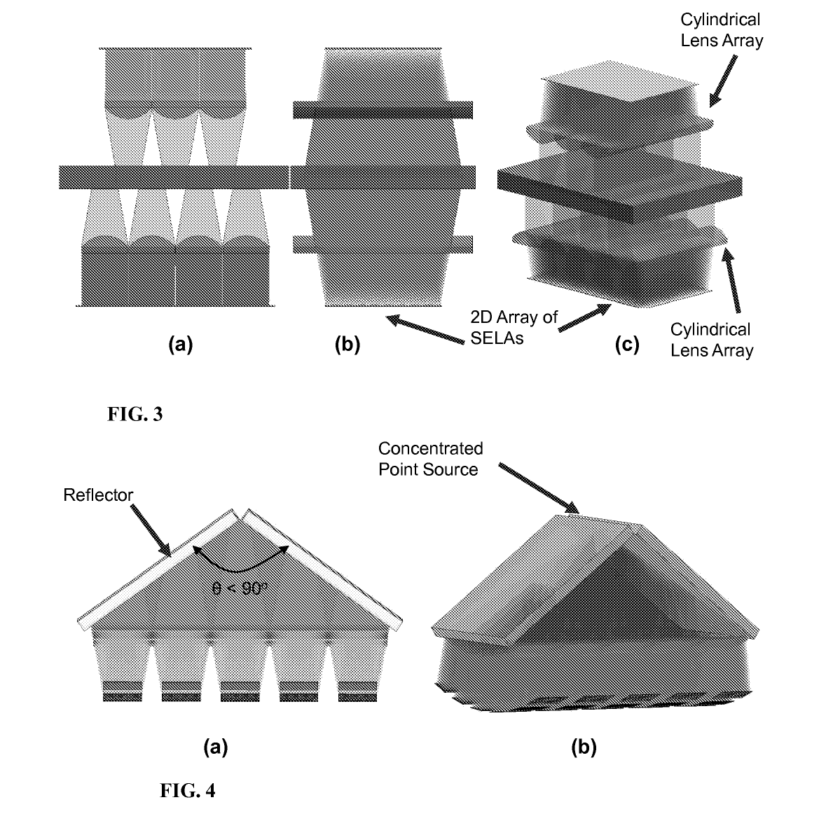

The array of SELAs can also be used to forma point source. FIGS. 4a and 4b illustrate a method of forming a point source from any of the above line source using mirrors of applicable shape. FIG. 4a is a lateral side-view of a curved 2D-stacked array of SELAs forming a point source with multiple cylindrical lenses and two slab reflectors. The angle between the two reflectors can be placed as required to guide the line source into a point source. FIG. 4b is an isometric illustration of the method of forming a point source with a line source and two reflectors.

### EXAMPLE 5

### A Method of Side-Stitching an Array of SE-DFB Lasers for Collimation

SELAs can be use side stitched to collimate the beam. FIG. 5a illustrates a method of side-stitching an array of SE-DFB lasers with cylindrical wavefront so that an array of them can then be collimated using a single cylindrical lens. FIG. 5b illustrates a method of forming a uniform illumination source using a stack of these cylindrical wave-front side-stitched arrays. FIG. 5c is an isometric illustration of the collimated cylindrically positioned SELAs. FIG. 5d is a lateral side-view of 2D-stacked cylindrically positioned SELAs forming a point source with multiple cylindrical lenses and an asphecrical lens. FIG. 5e is a longitudinal side-view of the 2D-stacked cylindrically positioned SELAs forming a point source with multiple cylindrical lenses and an aspherical lens. FIG. 5f is an isometric illustration of 2D-stacked cylindrically positioned SELAs forming a point source with multiple cylindrical lenses and an aspherical lens.

While this invention has been described in conjunction with the various exemplary embodiments outlined above, various alternatives, modifications, variations, improvements and/or substantial equivalents, whether known or that are or may be presently unforeseen, may become apparent to those having at least ordinary skill in the art. accordingly, the exemplary embodiments according to this invention, as set forth above, are intended to be illustrative not limiting. various changes may be made without departing from the spirit and scope of the invention. Therefore, the invention is intended to embrace all known or later-developed alternatives, modifications, variations, improvements and/or substantial equivalents of these exemplary embodiments.

What is claimed is:

1. A method of formatting a laser beam comprising:
using a surface-emitting distributed feedback (SE-DFB) laser array (SELA)
passing the beam through a cylindrical lens
wherein the beam of the laser is formatted.

2. The method of claim 1, wherein the beam is collimated.

3. The method of claim 1, wherein the beam forms a line source using a single cylindrical lens and a SELA which has a nearly collimated output beam in the longitudinal direction and a divergent beam in the lateral direction.

4. The method of claim 3, wherein a point source is formed by using one or more reflectors to guide the line source to a point source.

5. The method of claim 1, wherein the array is a two-dimensional array.

6. A method of forming a line source from multiple SELAs comprising:
passing the output beam through a single cylindrical lens.

7. The method of claim 6, wherein the line source is extended by stacking multiple SELAs in the lateral direction.

8. The method of claim 6, wherein the line source is intensified by stacking multiple SELAs in the longitudinal direction.

9. The method of claim 8, wherein the multiple SELAs is a two-dimensional array.

10. The method of claim 8, wherein multiple cylindrical lenses are used to form the line source.

11. A method of forming a concentrated line source from multiple SELAs comprising:
(a) positioning the SELAs at a constant radial distance from a line source;
(b) orienting the SELAs longitudinally and in the same longitudinal plane; and
(c) aligning one or more cylindrical focusing lens in the output beam path;
whereby the concentrated line source is generated.

12. The method of claim 11, wherein an intensified line source is formed by using a two-dimensional array of SELAs in step (a).

13. The method of claim 11, wherein a plurality of cylindrical focusing lenses are aligned to the SELAs generating a concentrated line source.

14. A method of pumping a solid-state or gas gain media using an array of SELAs comprising:
stacking, periodically two or more SELA arrays with one or more cylindrical lens arrays.

15. A method of collimating multiple SELAs using a single cylindrical lens (FIG. 5A) comprising:
locating the multiple SELAs at a radial distance away from a virtual line source; and
locating a single cylindrical lens at a distance such that the focal length of the lens is approximately equal to its location from the virtual line source.

16. A method of collimating a two dimensional array of SELAs comprising:
side-stitching the array of SELAs using a single cylindrical lens.

17. The method of claim 16, wherein multiple cylindrical arrays are placed side by side to form a larger area of collimated beam.

18. The method of claim 17, wherein a point source is formed from the collimated beam using an aspherical lens.
